(19) United States
(12) Patent Application Publication
(10) Pub. No.: US 2015/0274484 A1
(43) Pub. Date: Oct. 1, 2015

(54) CONVEYING DEVICE

(71) Applicant: CANON KABUSHIKI KAISHA, Tokyo (JP)

(72) Inventor: Ryoya Shinjo, Kawasaki-shi (JP)

(21) Appl. No.: 14/673,989

(22) Filed: Mar. 31, 2015

(30) Foreign Application Priority Data
Apr. 1, 2014 (JP) 2014-075260

(51) Int. Cl. B65H 75/28; B65H 16/02; B65H 20/00; B41J 15/04

(52) U.S. Cl. CPC B65H 75/28; B41J 15/04; B65H 16/02; B65H 20/00

(57) ABSTRACT

A conveying device includes a supply section in which a roll sheet is mounted, a take-up section configured to reel the roll sheet mounted in the supply section onto a take-up core, and a guide sheet configured to connect the roll sheet mounted in the supply section to the take-up core.

### BACKGROUND OF THE INVENTION

1. Field of the Invention

The present invention relates to a conveying device that can reel a roll sheet.

2. Description of the Related Art

Among printing apparatuses using a roll sheet as a printing medium, there is a printing apparatus including a conveying mechanism that supplies a roll sheet from a supply section and reels the roll sheet in a take-up section. When a roll sheet is loaded in the conveying mechanism, a roll sheet wound on a supply core is mounted in the supply section, and a leading edge of the roll sheet is drawn out. The leading edge of the roll sheet is guided to an image forming section located downstream of the supply section in a conveying direction of the roll sheet, and is further attached to a take-up core in the take-up section located downstream of the image forming section in the conveying direction of the roll sheet. Since the roll sheet mounted in the supply section is warped, it takes much labor to draw out and pass the leading edge of the roll sheet through a conveying path.

Accordingly, Japanese Patent Laid-Open No. 2-127068 discloses a loading method that overcomes the above-described problem. In the disclosed loading method, a guide sheet fixed at one end to a supply core is used.

The disclosed loading method is performed in an apparatus including a supply section and a take-up section that can reel a roll sheet, a guide sheet, and an image forming section. The supply section and the take-up section are provided opposed to each other with the image forming section being disposed therebetween. The length of the guide sheet is substantially equal to the distance between the supply section and the take-up section. One end of the guide sheet is fixed to a supply core in the supply section, and the other end of the guide sheet is removably attached to a trailing edge of the roll sheet.

One edge of the roll sheet contained in the take-up section is attached to the guide sheet, and the other edge of the roll sheet is fixed to the take-up core. Reeling is performed from this state in the supply section. After the reeling in the supply section is finished, image formation is performed. During the image formation, the roll sheet is reeled by the take-up section.

When the roll sheet is completely reeled by the take-up section, the other end of the guide sheet also passes through the image forming section, and reaches the take-up section. Then, the guide sheet is removed from the roll sheet, the roll sheet wound on the take-up core is taken out of the take-up section, and a roll sheet wound on a new take-up core is mounted in the take-up section. The other end of the guide sheet is attached to an edge of the roll sheet wound on the take-up core, which is located on the outer periphery (corresponding to a trailing edge in the conveying direction from the supply section to the take-up section). By sequentially reeling the guide sheet and the roll sheet around the supply core in the supply section in this state, mounting of the roll sheet in the supply section is completed, and loading of the roll sheet in the conveying mechanism is also completed.

In this loading method, when a roll sheet is reeled in the supply section, the roll sheet mounted in the take-up section moves along the conveying path toward the supply section as if it was pulled by the guide sheet. Hence, the user does not need to feed the roll sheet along the conveying path. Further, when the roll sheet wound on the take-up core is mounted in the take-up section, it is only necessary to attach the edge on the outer periphery of the roll sheet wound on the take-up core (corresponding to the trailing edge in the conveying direction from the supply section to the take-up section) to the guide sheet, and there is no need to attach the roll sheet to the supply core.

In the disclosed loading method, after the roll sheet contained in the take-up section is reeled once in the supply section, the roll sheet in the supply section is sequentially reeled in the take-up section for image formation. The replaced roll sheet is reeled in the supply section and the take-up section until image formation is finished. If the roll sheet is reeled in a skewing state, it is necessary to correct skewing after opening the printing apparatus once. This requires labor.

In the structure disclosed in the above publication, the supply core to which the guide sheet is to be attached is not removed from the printing apparatus, but is used repeatedly. In another type of printing apparatus, a roll sheet wound on a supply core is replaced together with the supply core. To such a printing apparatus, the guide sheet fixed at one end to the supply core disclosed in the above publication is not applicable.

### SUMMARY OF THE INVENTION

The present invention provides a conveying device that allows easy loading of a roll sheet to be replaced together with a supply core.

A conveying device according to an aspect of the present invention includes a supply section in which a roll sheet is mounted, a take-up section configured to reel the roll sheet mounted in the supply section onto a take-up core, and a guide sheet configured to connect the roll sheet mounted in the supply section to the take-up core. The guide sheet includes a sheet portion having flexibility, a first fixing part provided in a first end portion of the sheet portion to removably fix the first end portion to at least the take-up core, and a second fixing part provided in a second end portion of the sheet portion opposite from the first end portion to removably fix the second end portion to the roll sheet.

Further features of the present invention will become apparent from the following description of exemplary embodiments with reference to the attached drawings.

### BRIEF DESCRIPTION OF THE DRAWINGS

FIG. 1 is a schematic cross-sectional view of a printing apparatus including a conveying mechanism according to a first embodiment.

FIG. 2 is a schematic cross-sectional view of a guide sheet in the first embodiment.

FIG. 3 is a flowchart of a loading operation in the first embodiment.

FIG. 4 is a perspective view of the principal part of the conveying mechanism, illustrating the loading operation in the first embodiment.

FIG. 5 is a perspective view of the principal part of the conveying mechanism, illustrating a state in which guide sheets are attached to a take-up core.

FIG. 6 is a perspective view of the guide sheets reeled around the take-up core.

FIG. 7 is a cross-sectional view of the printing apparatus at the completion of double-side printing.

FIG. 8 is a schematic cross-sectional view of a printing apparatus including a conveying mechanism according to a second embodiment.

FIG. 9 is a flowchart of a loading operation in the second embodiment.

FIG. 10 is a perspective view of the principal part of the conveying mechanism, illustrating the loading operation in the second embodiment.

FIG. 11 is a flowchart of a loading operation in a third embodiment.

FIG. 12 is a perspective view of the principal part of a conveying mechanism, illustrating the loading operation in the third embodiment.

FIG. 13 is a cross-sectional view of an attachment assist sheet.

FIG. 14 is a perspective view of the principal part of a conveying mechanism according to a fourth embodiment, illustrating an operation of loading a roll sheet of the minimum width corresponding to the conveying mechanism.

FIG. 15 is a perspective view of the principal part of the conveying mechanism of the fourth embodiment, illustrating an operation of loading a roll sheet of a width different from the minimum width corresponding to the conveying mechanism.

### DESCRIPTION OF THE EMBODIMENTS

A conveying device according to the present invention will be described below with reference to the drawings. In the description, the conveying device of the present invention is applied to a printing apparatus.

### First Embodiment

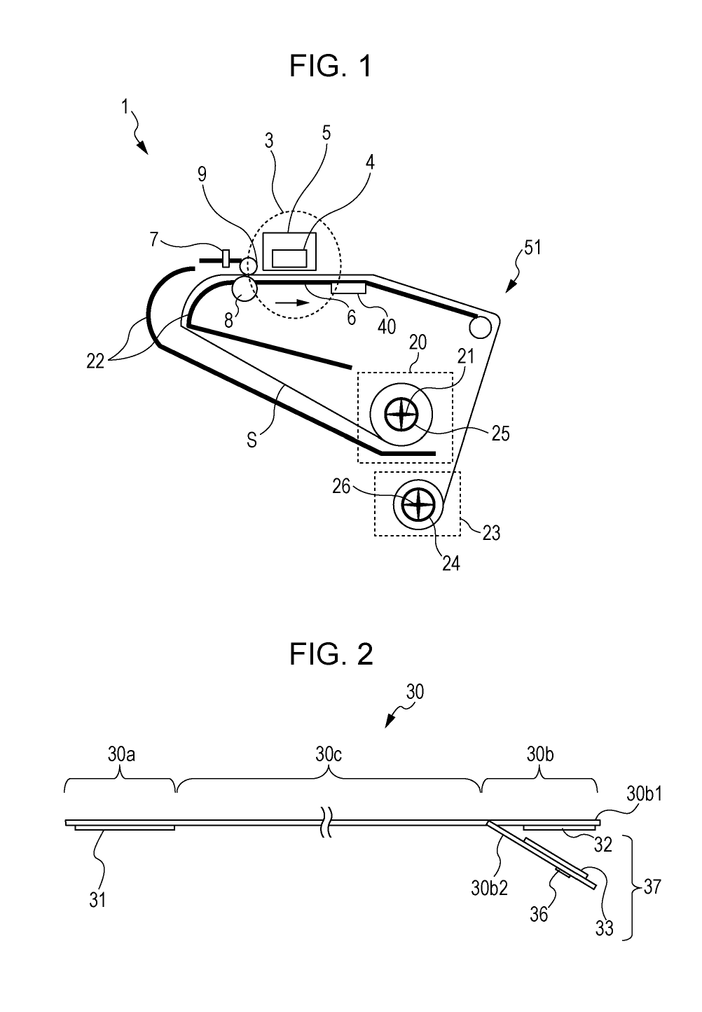

FIG. 1 is a schematic cross-sectional view of a printing apparatus including a conveying mechanism according to a first embodiment. First, a conveying mechanism according to the first embodiment will be described. In the first embodiment, a roll sheet is used as a printing medium.

A conveying mechanism 51 includes a supply section 20 including a supply spool shaft 21 rotatably supported at both ends, a take-up section 23 including a take-up spool shaft 26 similarly rotatably supported at both ends, and a conveying roller 8 that conveys a roll sheet S from the supply section 20 to the take-up section 23.

A roll sheet S is wound around a supply core 25, and the supply core 25 is attached to the supply spool shaft 21. The roll sheet S is reeled by a take-up core 24 attached to the take-up spool shaft 26.

Between the supply section 20 and the take-up section 23, a roller pair formed by the conveying roller 8 and pinch rollers 9 to be driven along with the conveying roller 8 is disposed to convey the roll sheet S from the supply section 20 to the take-up section 23. The conveying roller 8 and the pinch rollers 9 can be moved apart from and closer to each other. Between the supply section 20 and the conveying roller 8, a conveying guide pair 22 having a U-turn shape is provided to guide the roll sheet S from the supply section 20 to the conveying roller 8. Between the conveying roller 8 and the take-up section 23, a conveying guide member 40 formed of stainless steel is provided. In the present invention, stainless steel is magnetic stainless steel.

In addition to the above-described conveying mechanism 51, the printing apparatus 1 includes an image forming section 3 provided between the conveying roller 8 and the take-up section 23. The image forming section 3 includes a head 4 for ejecting liquid, a carriage 5 capable of reciprocating in a width direction (main scanning direction) of the roll sheet S while the head 4 is mounted thereon, and a platen 6 provided opposed to the head 4 to support the roll sheet S and to hold the roll sheet S in a substantially planar form by suction. The conveying guide member 40 is located closer to the take-up section 23 than the platen 6. In the first embodiment, the conveying guide member 40 is located adjacent to the platen 6.

First, an image forming process will be described. In the image forming section 3, while conveyance of the roll sheet S is stopped, the carriage 5 is scanned in the main scanning direction. At this time, one line is printed on the roll sheet S by ejecting liquid from the head 4 onto the roll sheet S. When printing of one line is finished, the roll sheet S is conveyed by a predetermined amount by the roller pair of the conveying roller 8 and the pinch rollers 9 in a direction of arrow in FIG. 1 perpendicular to the main scanning direction (sub-scanning direction). Then, one line is printed again while scanning the carriage 5 in the main scanning direction. In this way, printing is performed for each line on the roll sheet S while repeating intermittent conveyance of the roll sheet S so as to form an image.

Next, a printing-medium conveying process will be described. A leading edge of the roll sheet S drawn out from the supply section 20 passes through the conveying guide pair 22, and is then nipped by the conveying roller 8 and the pinch rollers 9. A manner in which the leading edge of the roll sheet S is conveyed to the conveying roller 8 will be described in a later description of a loading operation.

The roll sheet S is sequentially fed out to the image forming section 3 by driving of the conveying roller 8. At this time, rotational brake force is constantly applied to the supply spool shaft 21 in the supply section 20 by the action of an unillustrated torque limiter. Hence, a predetermined tension is constantly applied to the drawn-out roll sheet S, and therefore, the roll sheet S does not sag in the conveying path. While the roll sheet S is passing through the image forming section 3, the above-described image forming process is executed.

After printing on the roll sheet S is performed in the image forming section 3, the roll sheet S is guided to the take-up section 23, and is sequentially reeled around the take-up core 24 attached to the take-up spool shaft 26 in the take-up section 23. The take-up spool shaft 26 continuously receives reeling driving force from an unillustrated take-up motor. Between the take-up spool shaft 26 and the take-up motor, an unillustrated torque limiter is provided so that the take-up motor idles when a tension greater than the predetermined tension is generated.

As described above, the action of the two torque limiters, driving of the conveying roller 8, and driving of the take-up spool shaft 26 allow continuous printing on one roll sheet S to be stably performed.

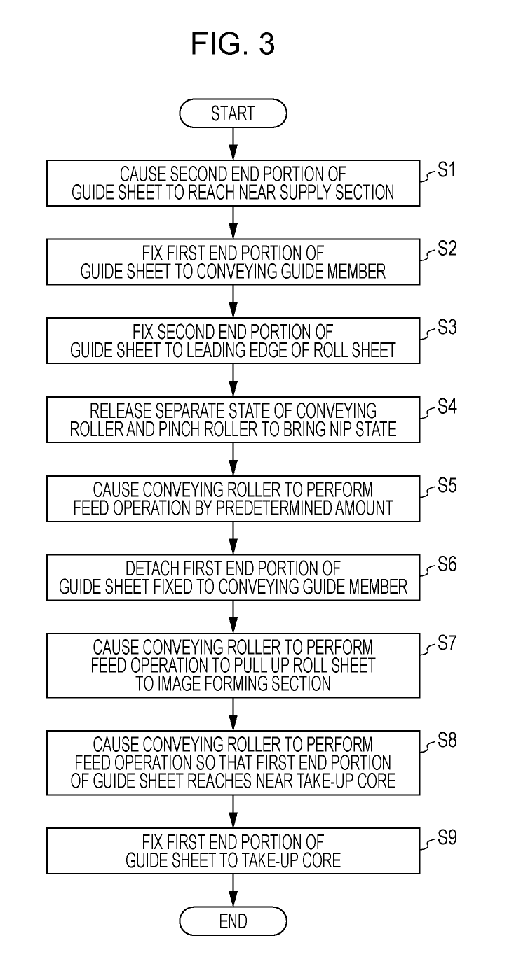

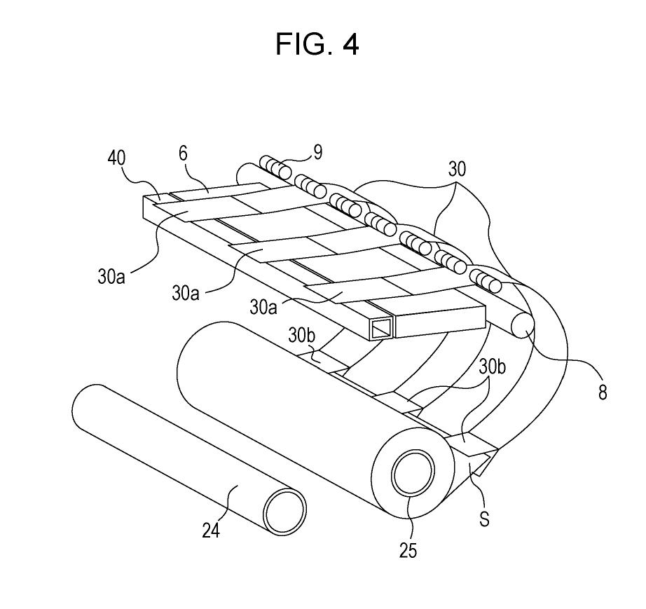

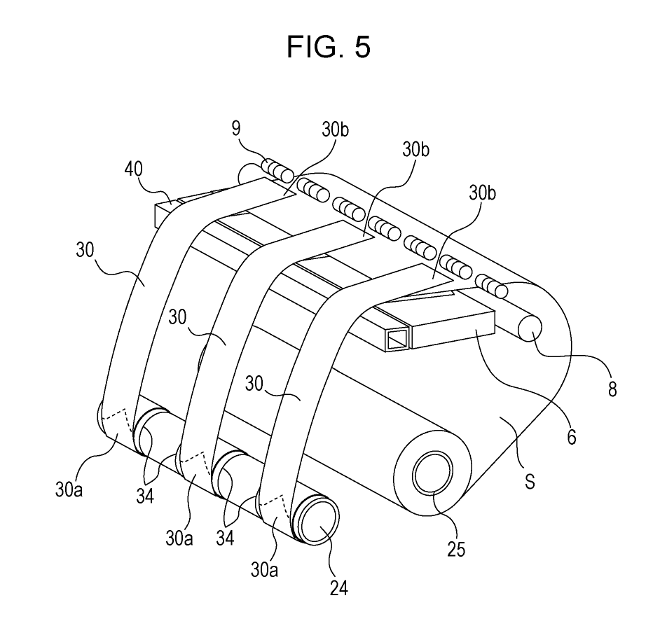

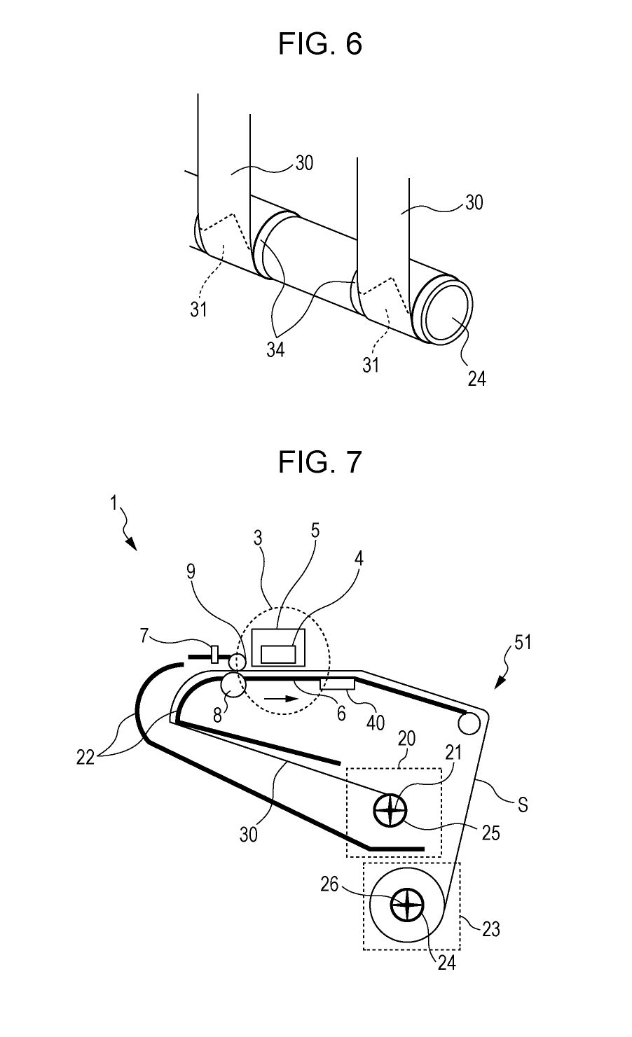

The image forming process and the printing-medium conveying process have been described above. Next, a loading operation of the roll sheet S, which characterizes the present invention, will be described. In the present invention, an attachment-type guide sheet is used. FIG. 2 is a schematic cross-sectional view of a guide sheet in the first embodiment, FIG. 3 is a flowchart of a loading operation in the first embodiment, and FIG. 4 is a perspective view of the principal part of the conveying mechanism, illustrating the loading operation in the first embodiment. FIG. 5 is a perspective view of the principal part of the conveying mechanism, illustrating a manner in which guide sheets are attached to the take-up core. FIG. 6 is a perspective view of the guide sheets wound on the take-up core.

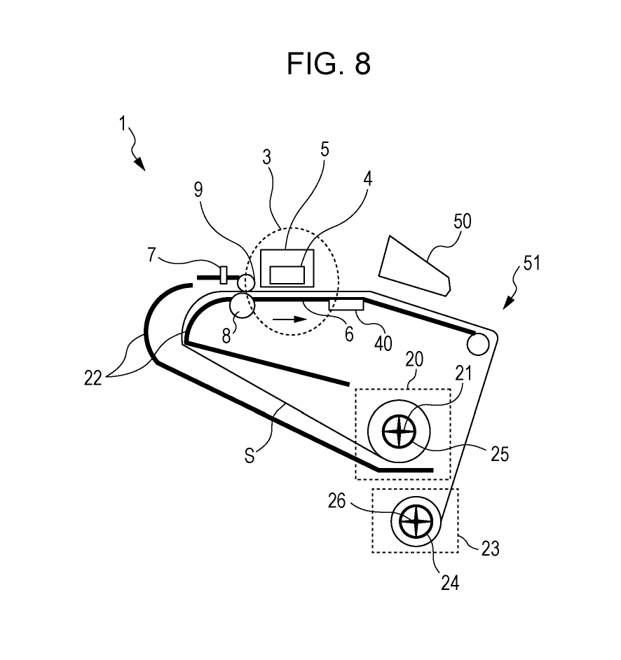

First, a guide sheet 30 of the first embodiment will be described. A magnet 31 serving as a first fixing part is provided on one surface of a first end portion 30a at one end of a guide sheet 30. The magnet 31 is removable from the take-up core 24 and fixed members 40 and 50 (see FIG. 8). A second end portion 30b at the other end of the guide sheet 30 opposite from the first end portion 30a is shaped like a flap divided into a first sheet portion 30b1 and a second sheet portion 30b2. The guide sheet 30 linearly extends from the first end portion 30a to the first sheet portion 30b1 of the second end portion 30b. In the second end portion 30b, a magnet 32 and a steel sheet 33 are provided on opposed surfaces of the first sheet portion 30b1 and the second sheet portion 30b2, respectively. The magnet 32 and the steel sheet 33 constitute a second fixing part 37. The second fixing part 37 is removably attached to a leading edge of the roll sheet S. The magnet 31 and the magnet 32 are provided in the first end portion 30a and the first sheet portion 30b1, respectively, so as to face in the same direction.

Next, a loading operation will be described.

The second end portion 30b of the guide sheet 30 is inserted from a side of the image forming section 3 into a gap between the conveying roller 8 and the pinch rollers 9 that are in a separate state. Then, the second end portion 30b of the guide sheet 30 is fed to a position near the supply section 20 toward the upstream side in the conveying direction of a roll sheet S (S1).

Next, the first end portion 30a of the guide sheet 30 is fixed to the conveying guide member 40 (S2). The first end portion 30a has the magnet 31, and the conveying guide member 40 is formed of stainless steel. Hence, the first end portion 30a can be fixed to the conveying guide member 40 by magnetic force. That is, the conveying guide member 40 is a fixed member to which the first end portion 30a of the guide sheet 30 is fixed.

In the first embodiment, the guide sheet 30 is disposed at each of both ends and center of the roll sheet S in the width direction (see FIG. 4). For this reason, three guide sheets 30 are set by repeating, twice, the step of feeding the second end portion 30b of the guide sheet 30 to the position near the supply section 20 (S1) and the step of fixing the first end portion 30a of the guide sheet 30 to the conveying guide member 40 (S2). Once the first end portion 30a is fixed to the conveying guide member 40, the guide sheet 30 does not fall off the conveying guide member 40 owing to its own weight even if the user releases the guide sheet 30 fixed to the conveying guide member 40.

After the first end portion 30a of each of the three guide sheets 30 is fixed to the conveying guide member 40, a step of fixing the second end portion 30b of each guide sheet 30 is performed. The second end portion 30b of the guide sheet 30 is fixed to the leading edge of the roll sheet S wound on the supply core 25 attached to the supply spool shaft 21 in the supply section 20 (S3).

The second end portion 30b of the guide sheet 30 branches into the first sheet portion 30b1 and the second sheet portion 30b2 in the flap form. The magnet 32 and the steel sheet 33 are provided on the opposed surfaces of the first sheet portion 30b1 and the second sheet portion 30b2, respectively. For this reason, the roll sheet S can be fixed by the magnet 32 and the steel sheet 33 with the leading edge thereof being clamped between the first sheet portion 30b1 and the second sheet portion 30b2. The two remaining guide sheets 30 are also subjected to the step of fixing the second end portion 30b to the leading edge of the roll sheet S (S3).

Next, the conveying roller 8 and the pinch rollers 9 are released from the separate state, and are moved closer to each other to nip the guide sheet 30 (S4). When it is detected by an unillustrated sensor that the separate state of the conveying roller 8 and the pinch rollers 9 is released, the conveying roller 8 performs a Feed operation to convey the guide sheet 30 by a predetermined amount toward the take-up section 23, that is, toward the downstream side in the conveying direction (S5).

At this point, the first end portion 30a of the guide sheet 30 is fixed to the conveying guide member 40. Hence, by the above-described Feed operation, the guide sheet 30 is sagged on the downstream side of the conveying roller 8. In this state, the first end portion 30a of the guide sheet 30 is unfixed from the conveying guide member 40 (S6). By sagging the guide sheet 30 on the downstream side of the conveying roller 8 and then unfixing the first end portion 30a from the conveying guide member 40, the first end portion 30a moves downstream of the conveying guide member 40, and is not fixed to the conveying guide member 40.

After that, when the Feed operation of the conveying roller 8 is performed, for example, by operating an unillustrated operation panel, the roll sheet S is conveyed downstream in the conveying direction as if it was drawn out by the guide sheet 30, and then reaches the image forming section 3 (S7).

The guide sheet 30 is conveyed toward the take-up section 23 in a manner such that the second sheet portion 30b2 of the second end portion 30b of the guide sheet 30 is in contact with the conveying guide member 40 and the platen 6. For this reason, the first sheet portion 30b1 of the second end portion 30b of the guide sheet 30 is not in contact with the conveying guide member 40 and the platen 6. Thus, the magnet 32 in the first sheet portion 30b1 is not fixed to the conveying guide member 40 and the platen 6.

After the leading edge of the roll sheet S reaches the conveying roller 8, the guide sheet 30 and the roll sheet S are further conveyed downstream in the conveying direction by the Feed operation of the conveying roller 8 so that the first end portion 30a of the guide sheet 30 reaches the take-up core 24 in the take-up section 23 (S8). While the step of causing the roll sheet S to reach the image forming section 3 (S7) and the step of causing the first end portion 30a of the guide sheet 30 to reach the take-up core 24 (S8) are described as separate steps for convenience of explanation, they are a series of steps actually.

Since the first end portion 30a of the guide sheet 30 is removable from the take-up core 24, it is fixed to the take-up core 24 (S9). Specifically, steel sheets 34 each having an adhesive tape are stuck on the take-up core 24 in accordance with the arrangement of three guide sheets 30, and the magnet 31 in the first end portions 30a of each guide sheet 30 is wound on the corresponding steel sheet 34 stuck on the take-up core 24, and is fixed by magnetic force. Since restoring force due to elastic deformation acts on the portion of the first end portion 30a of the guide sheet 30 wound on the take-up core 24 in a direction to peel the magnet 31, the portion of the first end portion 30a of the guide sheet 30 is formed of a highly flexible vinyl material.

FIG. 6 is a perspective view of the guide sheets 30 reeled on the take-up core 24. When any of the guide sheets 30 is attached to the take-up core 24 in a skewing state, the wound guide sheet 30 and the roll sheet S may be creased. For this reason, both edges of a magnet 31 in the first end portion 30a of the guide sheet 30 have their respective wavelike shapes in the direction from the first end portion 30a to the second end portion 30b. The wavelike shapes are such that both edges of the magnet 31 can be fitted together on the surface of the take-up core 24. Further, since the material of the first end portion 30a of the guide sheet 30 is a transparent vinyl material, if the guide sheet 30 is set in the skewing state, the user can easily and visually notice the skew.

When the step of fixing the first end portion 30a of the guide sheet 30 to the take-up core 24 (S9) is performed, the operation of loading the roll sheet S in the conveying mechanism 51 is completed. When a driving power supply for the take-up spool shaft 26 is provided, it is turned off beforehand. After the step of fixing the first end portion 30a of the guide sheet 30 to the take-up core 24 (S9), the driving power supply is turned on. For stable conveyance of the roll sheet S during printing, the guide sheet 30 has the function of transmitting tension, which is generated by driving torque applied to the take-up core 24, to the roll sheet S. For this reason, a PET (polyethylene terephthalate) sheet having flexibility and low stretchability is used as the material of a sheet portion 30c of the guide sheet 30 except for the end portions 30a and 30b. Further, since the guide sheet 30 is reeled on the take-up core 24 as it is, the second end portion 30b of the guide sheet 30 is formed of a highly flexible vinyl material for a reason similar to that of the first end portion 30a.

Still further, double-side printing can be performed after the roll sheet S reeled on the take-up core 24 is mounted in the supply section 20 again. In double-side printing, the roll sheet S is set with its printed surface being located on a side to be in contact with the platen 6. That is, in double-side printing, the winding direction of the roll sheet S is opposite from the winding direction of the roll sheet S set in the supply section 20 in one-side printing.

FIG. 7 is a cross-sectional view of the printing apparatus 1 at the completion of double-side printing. FIG. 7 illustrates a state in which double-side printing proceeds, and a trailing edge of the roll sheet S separates from the supply core 25 (the take-up core 24 used in one-side printing is mounted) and reaches the position near the conveying roller 8. Since the trailing edge of the roll sheet S corresponds to the leading edge in one-side printing, it is connected to the supply core 25 by the guide sheets 30 at the completion of double-side printing. Accordingly, tension is applied to the roll sheet S by an unillustrated torque limiter, similarly to one-side printing. This allows stable conveyance.

A marking 36 for suppressing reflection of infrared light is provided at one position on a surface of the second sheet portion 30b2 of each guide sheet 30 that is not opposed to the first sheet portion 30b1 (see FIG. 2). The marking 36 may be formed by applying an infrared absorbing coating material, or by exposing the magnet 32 from a hole provided in the second sheet portion 30b2 when the magnet 32 is black. The conveying mechanism 51 further includes a reflective sensor 7 that emits infrared light to the upstream side of the conveying roller 8 and detects reflection of the infrared light. The trailing edge of the roll sheet S is detected by detecting the marking 36 with the reflective sensor 7, and the printing operation of the printing apparatus 1 is finished on the basis of the detection, so that printing is not erroneously conducted on the guide sheet 30.

The above-described guide sheet 30 of the first embodiment is not fixed to any of the take-up core 24 and the supply core 25, but is independent. Further, a plurality of guide sheets 30 can be freely arranged in the width direction of the printing medium.

As can be known from the above description, each guide sheet 30 has the function of assisting in pulling up the leading edge of the roll sheet S from the supply section 20 to the image forming section 3. If the roll sheet S is mounted in the conveying mechanism 51 without using the guide sheet 30, the user needs to push in and pass the leading edge of the roll sheet S through the U-turn-shaped conveyance guide pair 22 from the supply section 20 toward the image forming section 3. Since the leading edge of the roll sheet S is drawn out from the state wound on the supply core 25, if the roll sheet S is greatly warped, it is difficult for the user to pass the leading edge of the roll sheet S through the conveyance guide pair 22. In addition, if the stiffness of the roll sheet S is low, even when the user manually pushes in the roll sheet S, the roll sheet S buckles in the conveying guide pair 22, and it is difficult to pass the roll sheet S through the conveying guide pair 22.

However, the guide sheet 30 is not warped unlike the roll sheet S, and the sheet stiffness of the guide sheet 30 can be adjusted by changing the material thereof. For this reason, the guide sheet 30 can be easily passed between the conveying roller 8 and the pinch rollers 9 and within the conveying guide pair 22. Therefore, the guide sheet 30 allows the user to easily load the roll sheet S in the conveying mechanism 51 in which the roll sheet S is directly mounted in the supply section 20 and is taken out from the take-up section 23 after printing.

Since the number of guide sheets 30 can be increased or decreased in the present invention, a roll sheet S of any width can be loaded by using the guide sheets 30 of the present invention.

Further, the roll sheet S is mounted in the supply section 20, is reeled in the take-up section 23 via the guide sheets 30, and is taken out from the take-up section 23. That is, since the guide sheets 30 are reeled only by the take-up section 23, but are not reeled by the supply section 20. For this reason, the possibility that the roll sheet S skews is reduced.

### Second Embodiment

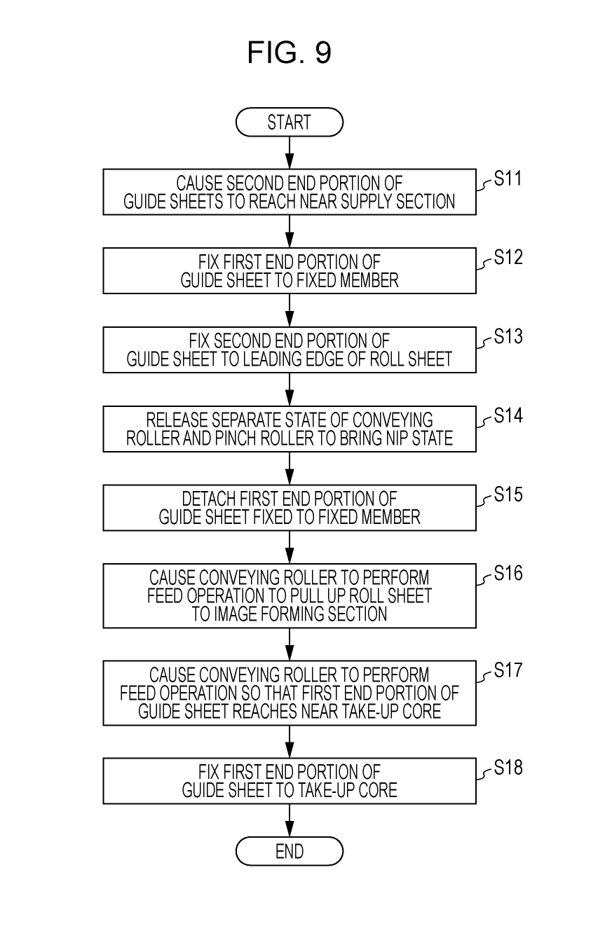

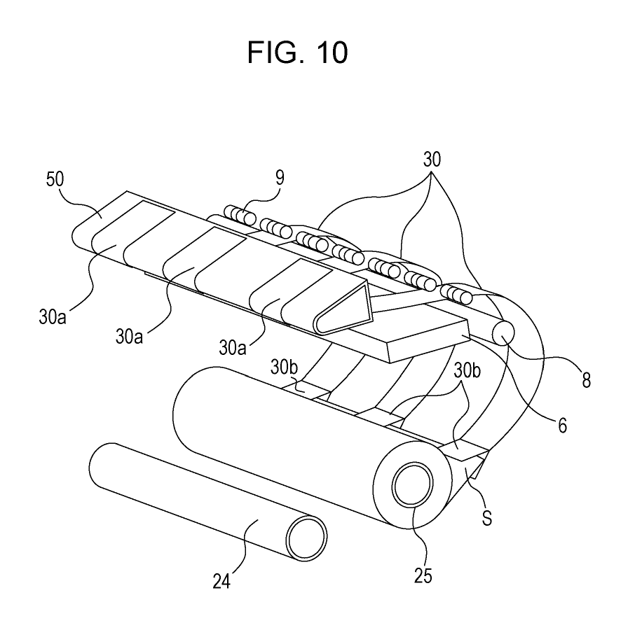

A second embodiment will be described with reference to FIGS. 8 to 10. Descriptions of structures similar to those in the above first embodiment are skipped, and the structures are denoted by the same reference signs. FIG. 8 is a schematic cross-sectional view of a printing apparatus including a conveying mechanism of the second embodiment. FIG. 9 is a flowchart of a loading operation in the second embodiment. FIG. 10 is a perspective view of the principal part of the conveying mechanism, illustrating a manner of the loading operation in the second embodiment. In the second embodiment, a fixed member 50 formed of stainless steel is provided on a downstream side of a conveying guide member 40 and at a position opposed to the conveying guide member 40 across a conveying path of a roll sheet S. The structure of guide sheets 30 is not different from that adopted in the first embodiment illustrated in FIG. 2.

Next, a loading operation in the second embodiment will be described. A second end portion 30b of a guide sheet 30 is inserted from a side of an image forming section 3 into a gap between a conveying roller 8 and pinch rollers 9 in a separate state. Then, the second end portion 30b of the guide sheet 30 is fed toward the upstream side in the conveying direction of a roll sheet S to reach a position near a supply section 20 (S11).

In this state, a first end portion 30a of the guide sheet 30 is fixed to the fixed member 50 (S12). Specifically, the first end portion 30a of the guide sheet 30 is folded back to be wound on the fixed member 50, and a magnet 31 in the first end portion 30a is fixed to the fixed member 50 by magnetic force with the first end portion 30a being disposed therebetween. In the second embodiment, three guide sheets 30 are used. For this reason, the step of feeding the second end portion 30b of the guide sheet 30 to the position near the supply section 20 (S11) and the step of fixing the first end portion 30a of the guide sheet 30 to the fixed member 50 (S12) are also performed for two remaining guide sheets 30.

Next, the second end portion 30b of the guide sheet 30 is fixed to a leading edge of a roll sheet S wound on a supply core 25 attached to a supply spool shaft 21 in the supply section 20 (S13). Then, the conveying roller 8 and the pinch rollers 9 are released from the separate state, and are moved closer to each other to nip the guide sheet 30 (S14).

After the guide sheet 30 is nipped by the conveying roller 8 and the pinch rollers 9, the first end portion 30a of the guide sheet 30 fixed to the fixed member 50 is placed on the conveying path (S15). After that, a Feed operation of the conveying roller 8 is performed so that the roll sheet S is conveyed downstream in the conveying direction while being drawn out by the guide sheet 30 until it reaches the image forming section 3 (S16). After the leading edge of the roll sheet S reaches the conveying roller 8, the first end portion 30a of the guide sheet 30 is caused to reach a take-up core 24 in a take-up section 23 (S17). While the step of causing the roll sheet S to reach the image forming section 3 (S16) and the step of causing the first end portion 30a of the guide sheet 30 to reach the take-up core 24 (S17) are described as separate steps for convenience of explanation, they are a series of steps actually.

Next, since the first end portion 30a of the guide sheet 30 is removably attached to the take-up core 24, it is fixed to the take-up core 24 (S18). By performing the step of fixing the first end portion 30a of the guide sheet 30 to the take-up core 24 (S18), the operation of loading the roll sheet S in the printing apparatus 1 is completed. When a driving power supply for a take-up spool shaft 26 is provided, it is turned off beforehand. After the step of fixing the first end portion 30a of the guide sheet 30 to the take-up core 24 (S18), the driving power supply is turned on.

In the second embodiment, the roll sheet S can be loaded in the printing apparatus 1 by using the guide sheet 30 while making the number of steps required for the loading operation smaller than in the first embodiment.

### Third Embodiment

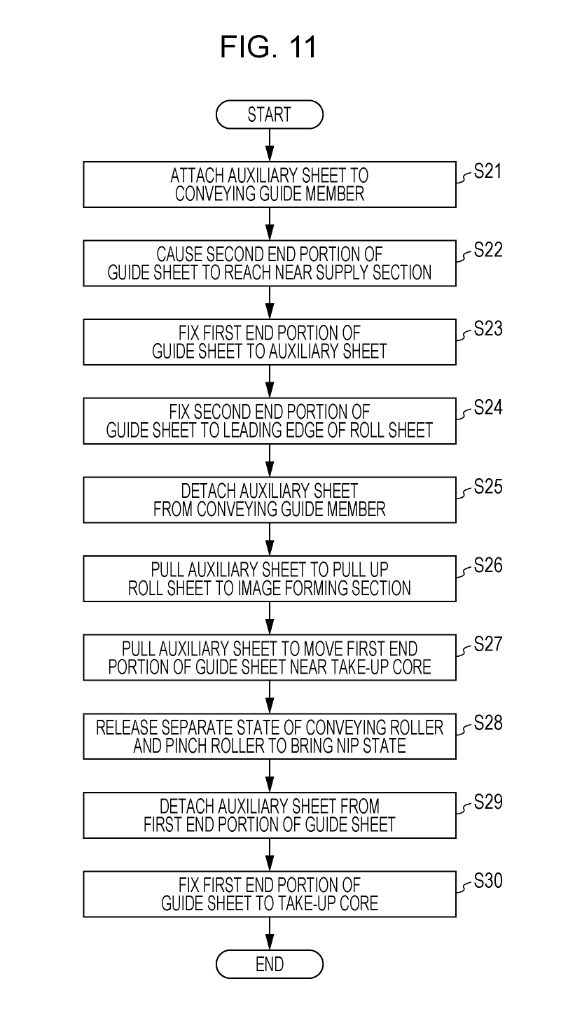

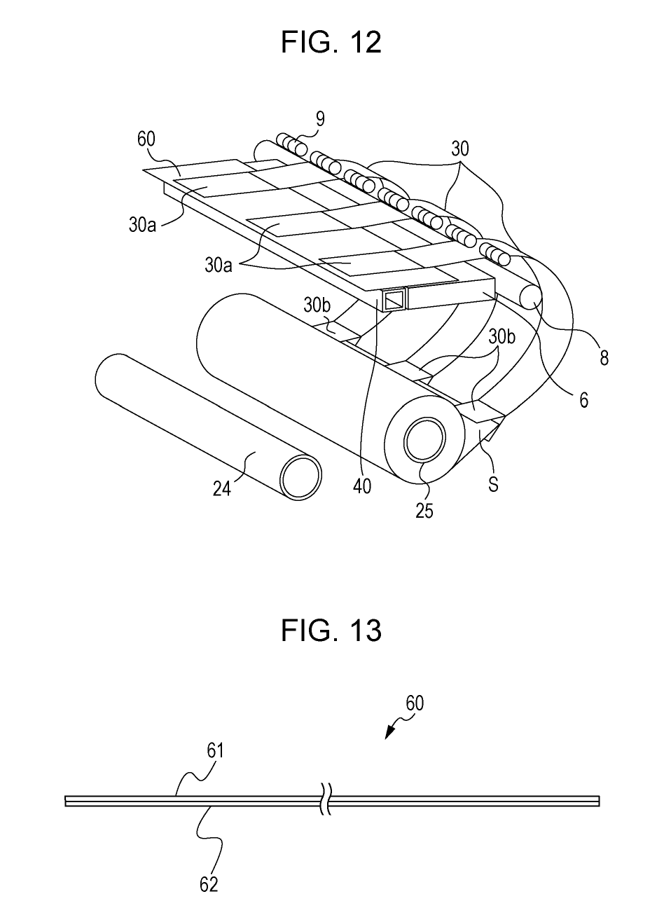

A third embodiment will be described with reference to FIGS. 11 to 13. Descriptions of structures similar to those in the above embodiments are skipped, and the structures are denoted by the same reference signs. FIG. 11 is a flowchart of a loading operation in the third embodiment. FIG. 12 is a perspective view of the principal part of a conveying mechanism, illustrating a manner of the loading operation in the third embodiment. FIG. 13 is a cross-sectional view of an attachment assist sheet. The third embodiment is characterized in that an auxiliary sheet 60 serving as an attachment separate from guide sheets 30 is used in addition to the guide sheets 30. The configuration of a printing apparatus 1 is similar to that adopted in the first embodiment illustrated in FIG. 1, and the structure of the guide sheets 30 is similar to that adopted in the first embodiment illustrated in FIG. 2.

A conveying mechanism 51 according to the third embodiment can convey roll sheets S of various widths, and the auxiliary sheet 60 has a width equal to or more than the width of the widest roll sheet S. The auxiliary sheet 60 is formed by stacking a steel sheet 61 and a magnet sheet 62. By placing the magnet sheet 62 in contact with a conveying guide member 40 formed of stainless steel, the auxiliary sheet 60 can be easily fixed to the conveying guide member 40.

Next, a loading operation in the third embodiment will be described. First, the auxiliary sheet 60 is disposed to cover a platen 6 and the conveying guide member 40 (S21). At this time, the magnet sheet 62 of the auxiliary sheet 60 is disposed opposed to the conveying guide member 40.

A second end portion 30b of each guide sheet 30 is inserted from a side of an image forming section 3 into a gap between a conveying roller 8 and a pinch rollers 9 in a separate state. Then, the second end portion 30b of the guide sheet 30 is fed upstream in the conveying direction of the roll sheet S to reach a position near a supply section 20 (S22).

Next, a first end portion 30a of the guide sheet 30 is fixed onto the auxiliary sheet 60, that is, onto the steel sheet 61 by magnetic force of the magnet 31 in the first end portion 30a (S23). Then, the second end portion 30b of the guide sheet 30 is fixed to the leading edge of the roll sheet S wound on a supply core 25 attached to a supply spool shaft 21 in the supply section 20 (S24). In the third embodiment, three guide sheets 30 are used. For this reason, the step of feeding the second end portion 30b of the guide sheet 30 to the position near the supply section 20 (S22) to the step of fixing the second end portion 30b to the leading edge of the roll sheet S (S24) are also performed for two remaining guide sheets 30.

Next, the auxiliary sheet 60 is pulled off the conveying guide member 40 (S25).

Then, the guide sheet 30 fixed to the auxiliary sheet 60 and the roll sheet S attached to the guide sheet 30 are pulled by pulling the auxiliary sheet 60 downstream in the conveying direction so that the leading edge of the roll sheet S reaches the image forming section 3 (S26). Actually, the auxiliary sheet 60 is pulled until the first end portion 30a of the guide sheet 30 reaches a take-up core 24 as a step to be performed with the step of causing the leading edge of the roll sheet S to reach the image forming section 3 (S26) (S27).

The conveying roller 8 and the pinch rollers 9 are released from the separate state (S28), and the auxiliary sheet 60 is pulled off the first end portion 30a of the guide sheet 30 (S29). The auxiliary sheet 60 is stored separately.

Then, the first end portion 30a of the guide sheet 30 is fixed to the take-up core 24 (S30). By performing the step of fixing the first end portion 30a of the guide sheet 30 to the take-up core 24 (S30), the operation of loading the roll sheet S in the printing apparatus 1 is completed. When a driving power supply for a take-up spool shaft 26 is provided, it is turned off beforehand. After the step of fixing the first end portion 30a of the guide sheet 30 to the take-up core 24 (S30), the driving power supply is turned off.

As can be known from the above description, the auxiliary sheet 60 functions as an assist member for simultaneously pulling three guide sheet 30 downstream in the conveying direction. By using the auxiliary sheet 60, the user can manually pull the three guide sheets 30, and can thereby draw the roll sheet S out from the supply section 20. For this reason, the user can intuitively draw out the roll sheet S.

### Fourth Embodiment

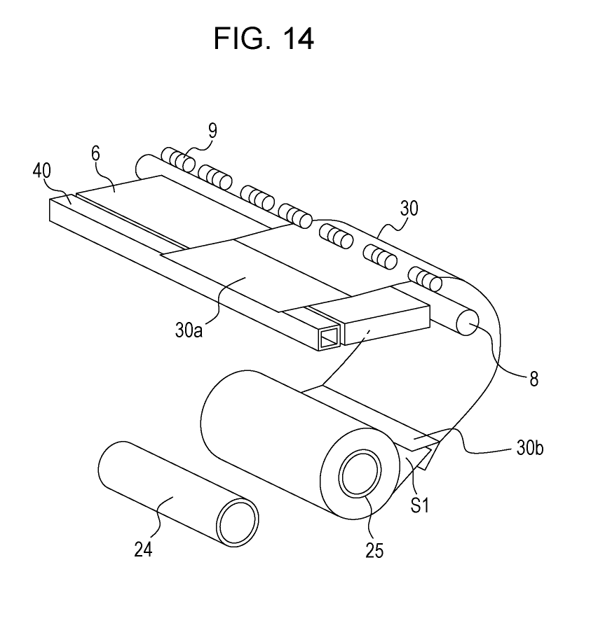

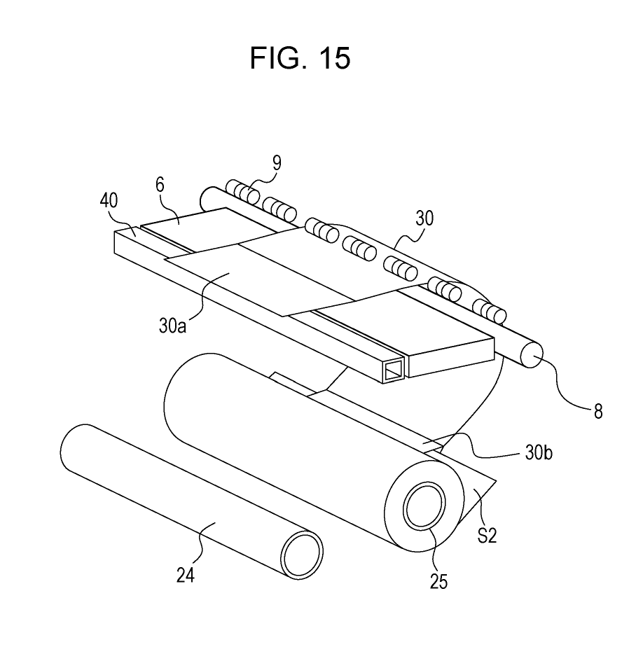

In the above embodiments, a plurality of guide sheets 30 are used. In a fourth embodiment, one guide sheet 30 is used. Details of the fourth embodiment will be described with reference to FIGS. 14 and 15. FIG. 14 is a perspective view of the principal part of a conveying mechanism, illustrating a loading operation of a roll sheet S1 of the minimum width corresponding to the conveying mechanism. FIG. 15 is a perspective view of the principal part of the conveying mechanism, illustrating a loading operation of a roll sheet S2 different from the roll sheet S1 of the minimum width. Structures similar to those adopted in the above embodiments are denoted by the same reference signs, and descriptions thereof are skipped.

When only one guide sheet 30 is used, the guide sheet 30 is equal to or narrower than the roll sheet S1 of the minimum width. When the width of the guide sheet 30 and the width of the roll sheet S1 are equal, as illustrated in FIG. 14, a second end portion 30b of the guide sheet 30 is attached to the roll sheet S1 so that both widthwise ends of the roll sheet S1 coincide with both widthwise ends of the guide sheet 30.

In contrast, when the guide sheet 30 is narrower than the roll sheet S1 of the minimum width, or when the roll sheet S2 of the width different from the minimum width is used, as illustrated in FIG. 15, it is recommended to attach the guide sheet 30 near the widthwise center of the roll sheet S1 or S2. This is because, if the guide sheet 30 is fixed at a position shifted to one side in the width direction of the roll sheet S1 or S2, unbalanced tension is applied to the roll sheet S1 or S2, and this may cause, for example, skewing.

The structure of the guide sheet 30 is similar to that in the first embodiment described with reference to FIG. 2, and a loading operation flow is similar to that in the first embodiment described with reference to FIGS. 3 to 6.

In the above-described first to fourth embodiments, the magnetic force of the magnet 31 or 32 is used as the part for fixing the guide sheet 30 to the leading edge of the roll sheet S, the take-up core 24, the conveying guide member 40, the fixed member 50, or the auxiliary sheet 60. This is because durability is considered to repeatedly use the guide sheet 30. However, the fixing part is not limited to the magnet 31 or 32, and for example, a re-peelable adhesive tape having a cost advantage may be used, although it is inferior in durability.

According to the present invention, when the leading edge of the roll sheet mounted in the supply section is guided to the take-up core, the roll sheet can be conveyed by conveying the guide sheet in a state in which the guide sheet is attached to the leading edge of the roll sheet. For this reason, the leading edge of the roll sheet can be passed through the conveying path without any influence of a warp of the roll sheet.

Further, since the conveying mechanism of the present invention is configured such that the roll sheet mounted in the supply section is reeled by the take-up section, the step of reeling the roll sheet is performed only once in the take-up section. For this reason, the possibility that the roll sheet skews is reduced.

According to the present invention, the roll sheet can be easily loaded in the conveying mechanism configured such that the roll sheet wound on the supply core is mounted in the supply section and the printed roll sheet is taken out from the take-up section.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-075260, filed Apr. 1, 2014, which is hereby incorporated by reference herein in its entirety.

What is claimed is:

1. A conveying device comprising:
a supply section in which a roll sheet is mounted;
a take-up section configured to reel the roll sheet mounted in the supply section onto a take-up core; and
a guide sheet configured to connect the roll sheet mounted in the supply section to the take-up core,
wherein the guide sheet includes a sheet portion having flexibility, a first fixing part provided in a first end portion of the sheet portion to removably fix the first end portion to at least the take-up core, and a second fixing part provided in a second end portion of the sheet portion opposite from the first end portion to removably fix the second end portion to the roll sheet.

2. The conveying device according to claim 1,
wherein a steel sheet is wound around the take-up core,
wherein a magnet to be removably attached to the steel sheet is provided as the first fixing part in the first end portion, and
wherein the second end portion is divided into a first sheet portion and a second sheet portion in a flap shape, a magnet is provided on one of opposed surfaces of the first sheet portion and the second sheet portion, a steel sheet is provided on the other of the opposed surfaces of the first sheet portion and the second sheet portion, and the magnet and the steel sheet in the second end portion constitute the second fixing part.

3. The conveying device according to claim 2,
wherein both edges of the magnet provided in the first end portion in a direction from the first end portion to the second end portion have respective wavelike shapes in the direction, and
wherein the wavelike shapes of one and the other of the both edges are to be fitted together.

4. The conveying device according to claim 1, further comprising a sensor,
wherein a marking to be detected by the sensor is provided in the second end portion of the guide sheet.

5. The conveying device according to claim 1, further comprising:
a fixed member provided adjacent to a conveying path of the roll sheet to support the first end portion.

6. The conveying device according to claim 5,
wherein a conveying roller is provided upstream or downstream of the fixed member in a conveying direction of the roll sheet to convey the roll sheet from the supply section to the take-up section.

7. A printing apparatus comprising:
the conveying device according to claim 1; and
an image forming section configured to perform printing on the roll sheet.
